(19) United States
(12) Patent Application Publication
(10) Pub. No.: US 2008/0041980 A1
(43) Pub. Date: Feb. 21, 2008

(54) SYSTEM AND METHOD FOR RECYCLING USING WASTE STREAM PRODUCTS

(76) Inventor: Larry Parmet, Braselton, GA (US)

Correspondence Address: NEEDLE & ROSENBERG, P.C., SUITE 1000, 999 PEACHTREE STREET, ATLANTA, GA, 30309-3915, US

(21) Appl. No.: 11/466,040

(22) Filed: Aug. 21, 2006

(51) Int. Cl. B02C 23/00

(52) U.S. Cl. 241/3; 241/17; 241/284

(57) ABSTRACT

A system and method for recycling using waste steam products in which a select quantity of compacted bundle(s) of non-adhered shredded plastic waste and a select quantity of compressed rubber bundle(s), formed from a rubber regrind composition such that a portion of the regrind composition is fused together, are delivered to and processed in a Banbury, which has a throat configured to receive the compacted bundle of shredded plastic waste and the compressed rubber bundle(s).

### FIELD OF THE INVENTION

This invention relates to a system and apparatus that is useful in the reclaimation of waste material. More particularly, the invention pertains to the reclaimation of pre/post consumer or industrial plastic waste material and non-vulcanized rubber waste material.

### BACKGROUND

Products made from or incorporating plastic and or rubber materials are part of almost any aspect of daily life. Generally, the plastic or rubber materials that are used to create these products are formed from virgin plastic materials that are produced from petroleum and are not made from existing stock. Literally millions of tons of plastic and rubber are produced and consumed each year. This volume of production yields a substantial amount of scrap material.

Of course, recycling plastic has a variety of benefits over creating virgin plastic from petroleum. Generally, less energy is required to manufacture an article from recycled plastic materials derived from post-consumer and post-industrial industrial waste materials and plastic scrap (collectively referred to in this specification as “plastic waste material”) than from the comparable virgin plastic. Recycling plastic materials obviates the need for disposing of the plastic materials or product. Further, in an era of reduced and more expensive petroleum material cost, the expense of production of the plastic is reduced as less further petroleum is necessary for the production of the recycled plastic.

When plastic materials are sent to be recycled, the feed streams rich in plastics may be separated into multiple product and by product streams. Generally, the recycling processes can be applied to a variety of plastics-rich streams derived from post-industrial and post-consumer sources. For example, these streams may include plastics from office automation equipment (printers, computers, copiers, etc.), white goods (refrigerators, washing machines, etc.), consumer electronics (televisions, video cassette recorders, stereos, etc.), consumables (diapers, plastic utensils, plastic cups, etc.), automotive shredder residue, packaging waste, household waste, building waste and industrial scrap (molding, non-woven, fiber, extrusions, etc.).

There continues to be a need for systems and methods that will further improve the efficiency with which waste plastic and rubber materials are reclaimed and the quality of the resultant reclaimed plastic. In particular, there is a continuing need for systems and methods that are useful for processing waste plastic material from any prospective plastic waste stream into reclaimed polymeric materials. Many variations exist, depending on at least the nature of the shredding operation. Plastics from more than one source of durable goods may be including in the mix of materials fed to a plastics recycling plant, which means that a very broad range of plastics may be included as potential sources of waste plastic material.

### SUMMARY

According to one embodiment of the invention, a system and method for recycling using waste stream products is provided. In one exemplary aspect, a select quantity of compacted bundle(s) of shredded plastic waste and a select quantity of compressed rubber bundle(s) are delivered to and processed in a Banbury. In one aspect, each rubber bundle is formed from a rubber regrind composition. In another aspect, at least a portion of the rubber the regrind composition is fused together. In a further aspect, the Banbury has a throat that is configured to receive the compacted bundle of shredded plastic waste and the compressed rubber bundle(s).

Other apparatus, methods, and aspects and advantages of the invention will be discussed with reference to the Figures and to the detailed description of the preferred embodiments.

### BRIEF DESCRIPTION OF THE FIGURES

The accompanying drawings, which are incorporated in and constitute a part of this specification, illustrate several aspects described below and together with the description, serve to explain the principles of the invention. Like numbers represent the same elements throughout the figures.

FIG. 1 is a schematic view of one embodiment of a system and method of reclaiming waste materials.

FIGS. 2A and 2B are schematic views of one embodiment of a plastic waste steam system configured to process a stream of plastic waste into a compacted, non-adhered bundle of a predetermined dimension.

FIG. 3 is a fragmentary schematic view, partially in section, of a bailing subsystem of the system and method illustrated in FIGS. 2A and 2B.

FIG. 4 is a schematic view of one embodiment of a rubber waste stream system configured to process a stream of waste rubber regrind composition into a compacted rubber bundle in which at least a portion of the rubber regrind composition is fused together.

FIG. 5 is a fragmentary schematic view, partially in section, of an exemplary means for compressing a rubber regrind composition of the system and method illustrated in FIG. 4.

FIG. 6 is a fragmentary schematic view, partially in section, of a Banbury being feed a predetermined number of bundles selected from the formed bundles of plastic waste and the formed bundles of rubber regrind composition.

### DETAILED DESCRIPTION OF THE INVENTION

The present invention can be understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a bundle” can include two or more such bundles unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

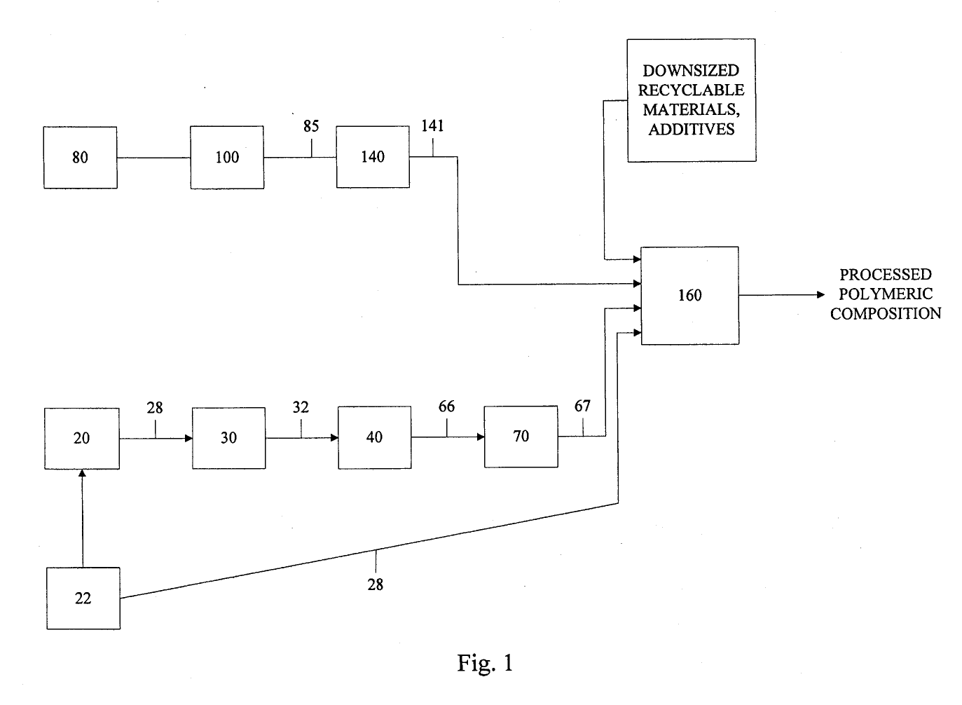

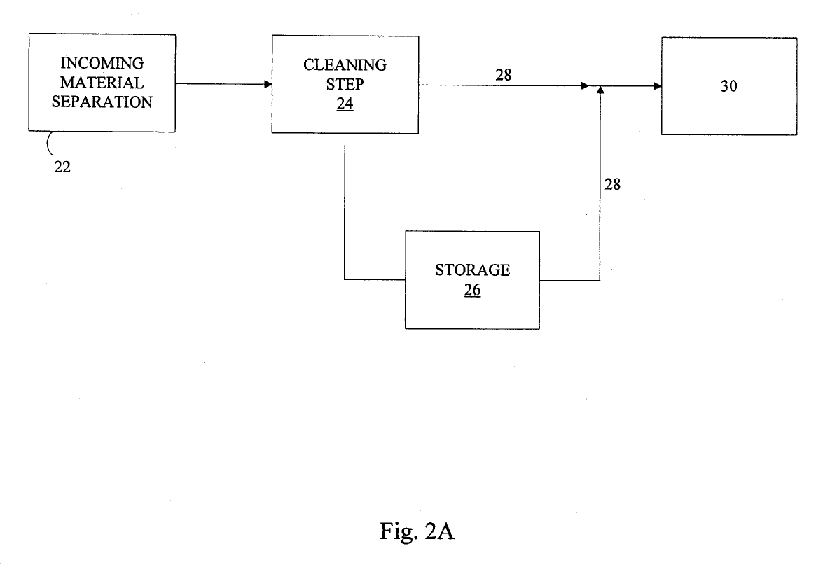

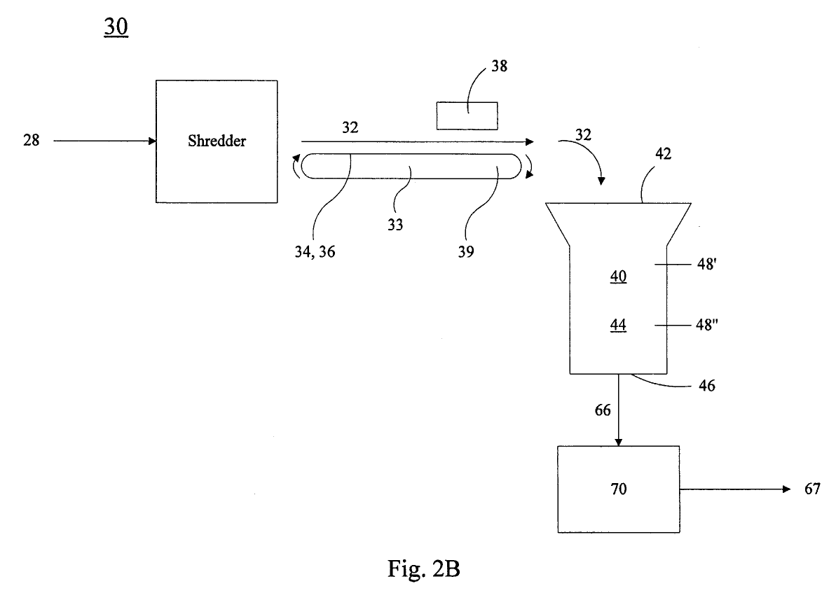

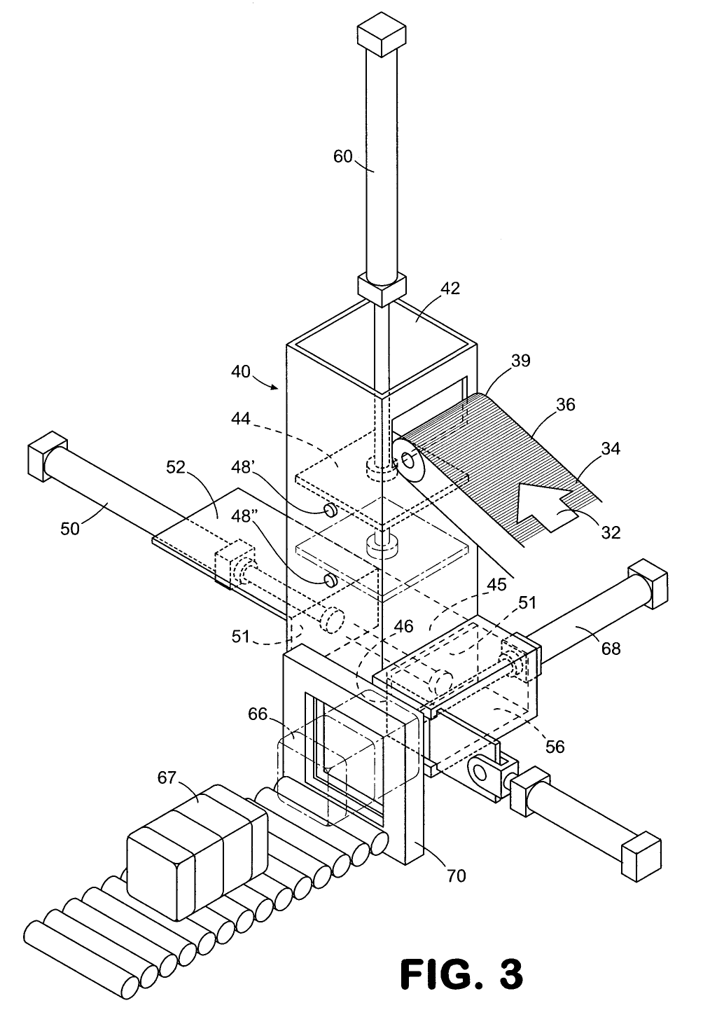

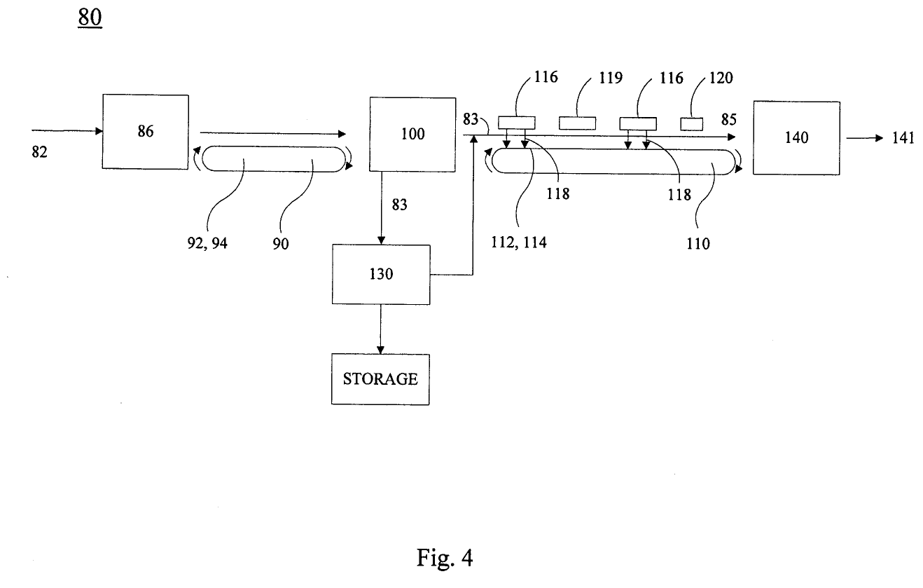

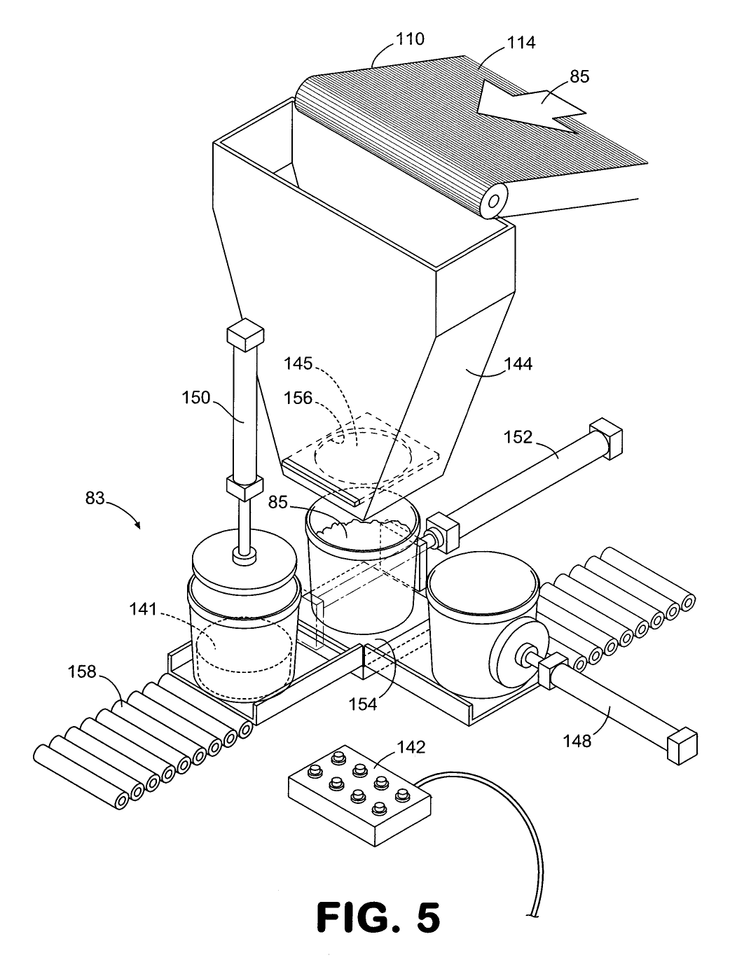

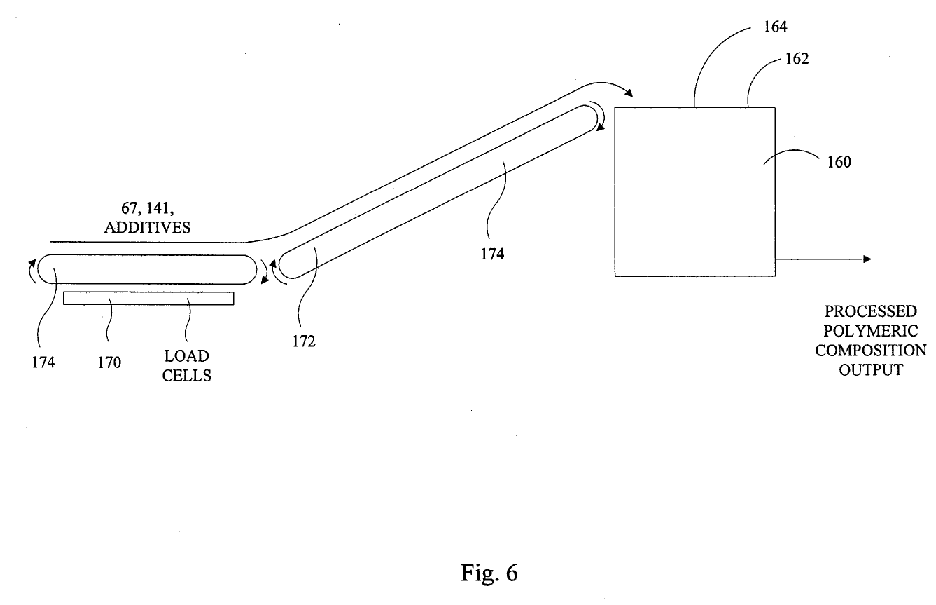

The exemplary recycling system 10 and method that is exemplified in FIG. 1 can be used to process plastic waste materials that are derived from multiple sources. In is contemplated that the present application can accept varied plastic waste materials from multiple product and by-product streams. Generally, the recycling processes of the present invention can be applied to a variety of plastics-rich streams derived from post-industrial and post-consumer sources. Further, it is contemplated that the exemplary system would allow for the processing of waste plastic material from any prospective plastic waste stream into the desired reclaimed polymeric materials. Certainly, it is also contemplated that plastics from more than one source of plastic waste materials may be including in the mix of materials fed to a plastics recycling plant, such as a Banbury, which means that a very broad range of plastics may be included as a potential source of waste plastic material. It is also contemplated that the plastic waste can comprise mixed and/or single grade plastic waste. Further, as exemplified in more detail below, the prospective plastic waste stream can comprise, without limitation, polypropylene, polyethylene, SBL rubber, and TPO. For example, again without limitation, the plastic waste streams can comprise polypropylene copolymers with ethylene, butane, vinyl acetate, etc.; polyethylene and copolymer with butene, octene, hexane, vinyl acetate, methyl acrylates, ethyl acrylates, butyl acrylates etc; styrene diblock, triblock and starblock polymers with butadiene, isoprene, ethylene-butylene, ethylene-propylene and thermoplastic olefins of blends of the above. As one skilled in the art will appreciate, alpha olefins, derivatives and engineering resins can form at least a portion of the prospective waste stream.

For example, and not meant to be limiting, some of the prevalent primary polymer types in the waste plastic materials are ABS, HIPS, PP, and PC. ABS is an impact modified styrene acrylonitrile copolymer of at least one alkenylaromatic monomer, at least one of acrylonitrile and methacrylonitrile and at least one aliphatic diene or rubber. See for example, “ABS Resins”, Kirk-Othmer Encyclopedia of Chemical Technology, Third Edition, Volume 18, John Wiley & Sons, pages 442-449 (1982), for a description of ABS Resins and their method of manufacture. Suitable alkenylaromatic compounds include, for example, styrene and its analogs, such as 2-methyl styrene, chloro- and bromostyrenes, 3,5 di-methylstyrene and t-butylstyrene. The aliphatic dienes include butadiene, isoprene or chloroprene. These ABS polymers may be prepared by methods such as, emulsion, bulk and melt polymerization. A common method for preparing such polymers includes a first step of polymerizing the diene monomer or monomers to form a latex, and subsequent grafting the alkenylaromatic and nitrile monomers and any other monomers onto said latex, also while the latex is in emulsion.

HIPS is an impact modified styrene copolymer of at least one alkenylaromatic monomer and at least one aliphatic diene or rubber. See for example, “HIPS Resins”, Kirk-Othmer Encyclopedia of Chemical Technology, Third Edition, Volume 18, John Wiley & Sons, pages 442-449 (1982) for a description of HIPS Resins and their method of manufacture. Suitable alkenylaromatic compounds include, for example, styrene and its analogs, such as 2-methyl styrene, chloro- and bromostyrenes, 3,5 di-methylstyrene and t-butylstyrene. The aliphatic dienes include butadiene, isoprene or chloroprene. In addition, some HIPS copolymers may contain a small amount of acrylonitrile to improve the environmental stress crack resistance for certain applications. These HIPS polymers may be prepared by methods similar to those used to prepare ABS polymers.

Polypropylene (“PP”) is a homopolymer or copolymer of propylene. See for example, Dorininghaus, Plastics for Engineers, Hanser, 1988, Chapter 4, for a description of PP Resins and their method of manufacture. Homopolymer polypropylene is typically isotactic, although syndiotactic and atactic forms are also produced. Propylene copolymers include semicrystalline block copolymers of propylene with ethylene, 1-butene, or higher a-olefins, semicrystalline sequential block copolymers of propylene, ethylene and a diene or amorphous statistical copolymers of propylene, ethylene and a diene. The diene can be 1,4-hexadiene, dicyclopentadiene or 3,5-ethylidene norbornene. Copoloymers including a diene are known as EPDM. Blends of homopolymer PP with EPDM are also considered part of the PP family. Alternative PP family members include monoaxially-oriented polypropylene (MOPP), biaxially-oriented polypropylene (BOPP), or sequentially biaxially-oriented polypropylene (SBOPP).

PC is a condensation polymer consisting of the carbonate functional group (—O—CO—O—) separated by aromatic groups along the polymer chain. Variations in the chemical structure of monomers or end groups may be employed to alter the properties of the PC product. See for example, Domininghaus, Plastics for Engineers, Hanser, 1988, Chapter 14, for a description of PC Resins and their method of manufacture.

Other plastics, such as styrene/acrylonitrile copolymers (SAN), polystyrene (PS), polyethylene (PE), polyamides (PA, also known as nylons), polyvinyl chloride (PVC), blends of polyphenylene ether with HIPS, PC or PA (PPO, or modified PPO), polyphenylene ethers, homopolymers and copolymers of polyethylene terephthalate (PET), and polybutylene terephthaltate, can also be found in contemplated waste plastic streams.

Other polymers that are used to make plastic products may also be present in the waste plastic material. Further, multiple colors and grades of ABS and HIPS, flame retardant ABS and HIPS, PP, PC, PC/ABS, polyethylene, polyesters, nylons and other plastics can be contained in the feed material to a plastics recycling plant.

Other examples of suitable polymeric waste streams for use in the described process include polyethylene, e.g., high density polyethylene (HDPE), low density polyethylene (LDPE), linear low density polyethylene (LLDPE), metallocene-catalyzed polyethylene, very low density polyethylene (VLDPE), ultrahigh molecular weight polyethylene (UHMWPE), and high performance polyethylene (HPPE).

One skilled in the art will appreciate that copolymers of ethylene can form a suitable polymeric waste stream. For example, and not meant to be limiting, vinyl acetate, methyl acrylates, ethyl acrylates, butyl acrylates, butyl and copolymers of isobutyl, isoprene, CPE, (neoprene) chlorinated, brominated butyls, styrene diblock and triblock elastomers of styrene isoprene, butadiene, ethylene-propylene, ethylene-butylene and the like can be suitable materials for the polymeric waste stream.

An exemplary rubber waste stream can be an ethylene copolymer rubber waste material. In various aspects, the rubber waste material can be any ethylene-containing rubber such as ethylene-propylene copolymer rubber (EPR), ethylene-propylene-diene (EPDM) rubber, and EPDM-type rubbers, for example. An EPDM-type rubber can be a terpolymer derived from the polymerization of ethylene and at least one different monoolefin monomer having from 3 to 10 carbon atoms, preferably 3 to 4 carbon atoms, and at least one polyunsaturated olefin having from 5 to 20 carbon atoms. Those monoolefins desirably have the formula CH₂ dbd.H—R where R is H or an alkyl of 1-12 carbon atoms and is preferably propylene. Desirably the repeat units from ethylene and the at least one monoolefin (and preferably from ethylene and propylene) are present in the polymer in weight ratios of 25:75 to 75:25 (ethylene:propylene) and constitute from about 90 to about 99.6 weight percent of the polymer. The polyunsaturated olefin can be a straight chained, branched, cyclic, bridged ring, bicyclic, fused ring bicyclic compound etc., and preferably is a nonconjugated diene. Repeat units from the nonconjugated polyunsaturated olefin are preferably from about 0.4 to about 10 weight percent of the rubber.

The present invention relates to a recycling system 10 and process for the production of a reclaimed product from plastic waste material and/or rubber waste material, which comprises at least three distinct stages. In a plastic waste stream stage 20, plastic waste is baled into compacted bundles of a desired size and/or density. In a separate rubber waste steam stage 80, rubber waste is formed into patties of a desired size and/or density. In a processing stage 160, in one exemplified aspect, at least a portion of one compacted bundle of plastic waste and at least a portion of one patty of rubber waste are fed in a Banbury for processing into the desired reclaimed product.

In one embodiment, the plastic waste stream stage 20 can initially comprise optional material preparation operations 22 for the incoming plastic waste materials. It is contemplated that incoming plastic waste material can be delivered to the processing facility in many forms such as, without limitation, rolls with cardboard cores, large bails, loose non-woven sheets, and loose non-gathered material. The plastic waste stream can comprise, without limitation, any of the exemplary plastic waste materials discussed above. Further, it is contemplated that the incoming plastic waste material can be contaminated with, for example and not meant to be limiting, ink, colorant, filler, metallic coatings, adhesive, rubber, stabilizers, and the like.

In one aspect, the large bales of incoming plastic waste are broken down by removing any type of restraining devices such as wires or ties. Further, a conventional guillotine can be used to break down the rolls with cardboard cores such that the cardboard core can be removed. Optionally, a conventional blade, such as knifes and razor blades, could be used to remove film from the cardboard cores. In a further aspect, the debated and decored plastic waste as well as any other loose plastic waste material can be processed in a cleaning step 24 to remove particular contaminants. For example, during the intake process, an operator can manually remove any large items of debris, such as stakes, organic matter or other large non-plastic waste items and deposit such in a waste bin (not shown).

Optionally, the broken down or otherwise loose plastic waste materials, whether cleaned or not, can be stored, in a storage step 26, for subsequent handling. In one aspect, the material is stored in large containers or dumpers. In another aspect, the material is baled into large bales that can weigh several hundred pounds for management of the plastic waste material.

During subsequent operation of the plastic waste stream stage, the plastic material can be at least partially reduced in size to form shredded plastic waste in a shredding step 30. In various aspect, the plastic waste steam 28 can comprise, without limitation, the cleaned plastic waste stream, a non-cleaned plastic waste stream, a bale of any size, which is either received as a bale or is baled internally, any size roll of non-woven fiber or BOPP with the core removed, regrind plastic waste, non-woven scrap waste, and the like. In operation, the plastic waste is conveyed to a hopper of an industrial shredder. In one exemplary aspect, a shredder manufactured by Retech Film and Fiber Machines is used, model RG62/150 SPK FF. In another exemplary aspect, a shredder manufactured by SSI is used, model 3400-HSP. In one example, the plastic waste material can be conveyed to the hopper of the shredder via a forklift that is adapted to drop quantities of the plastic waste stream directly into the hopper of the shredder. In this aspect, and as one skilled in the art will appreciate, a plate can be used on the forklift to scoop up the material and a tilt plate can be actuated to slide the material into the hopper. Optionally, a dumping container mounted to the forklift can deposit the material into the hopper of the shredder. In another aspect, the plastic waste material can be conveyed to the hopper via conventional conveyor means or a conventional stationary dumper.

The industrial shredder is conventionally configured to reduce or downsize the material that is deposited into the shredder into discrete pieces having a desired maximum dimension. When the shredded plastic waste 32 is discharged from the shredder, it falls downwardly onto an upper run 34 of a conveyor belt 36 of a baling section conveyor 33. The conveyor belt of the baling section conveyor is supported at opposite ends by rollers and is driven by a motor (not shown). In one aspect, the conveyor belt of the baling section conveyor can be non-foraminous.

One shredding apparatus may be sufficient to reduce the size of the pieces of plastic waste material to that suitable for feeding to an extruding section. However, alternatively, it may be desirable to pass the initially shredded plastic waste material through at least one additional shredding apparatus. In that event, the discharge of the shredding apparatus is conveyed to the at least one additional shredding apparatus. In one aspect, the discharge from the last shredding apparatus in operation feeds the conveyor belt of the baling section conveyor and forms the source of shredded plastic waste.

In a further aspect, to remove any magnetic-responsive materials, such as metal that are subject to magnetic attraction, an electromagnet 38 can be disposed above a portion, such as the discharge end portion, of the bailing section conveyor belt 36. In one aspect, the magnet 38 is positioned sufficiently close to the shredded plastic waste stream 32 being conveyed to attract and remove any metallic objects from the shredded plastic waste steam.

The discharge end 39 of the conveyor belt of the baling section conveyor is positioned in communication with a baler 40. In one aspect, the baler 40 comprises a throat 42 that is in communication with the source of shredded plastic waste 32. In one example, the discharge end 39 of the baling section conveyor is positioned to overlie the throat 42 of the baler. The baler also comprises a material chamber 44 that is in communication with and underlies the throat. In one aspect, the material chamber defines an outlet port 46. In operation, the shredded plastic waste material 32 drops in from the top or throat of the baler an falls downwardly toward the bottom of the material chamber of the baler. In one aspect, the material chamber comprises at least one optical sensor 48 mounted therein the side wall of the material chamber. In another aspect, one optical sensor of the at least one optical sensors 48 is positioned in an upper portion of the material chamber such that, in operation, when the optical sensor 48′ senses that material has reached the level of the at least one optical sensor, which indicates that the material chamber of the baler is “full,” a signal is sent to the baling section conveyor to stop. In a further aspect, when the optical sensor senses that the material has dropped below the full level, a signal is sent to the baling section conveyor to resume feeding the shredded plastic waste into the intake of the baler.

In a further aspect, at least one of the at least one optical sensors 48″ is positioned in a lower portion of the material chamber. Preferably, it is positioned just above a compressing ram 50 that is configured to move along substantially horizontally path toward a vertical wall 56 at a bottom portion 45 of the material chamber 44. The compressing ram 50 has a front face 51 that is configured as the compressing surface and a top surface 52 that acts to block passage of the shredded material into the bottom portion 45 of the material chamber as the compressing ram is cycled.

In operation, when the optical sensor 48″ that is positioned in the lower portion of the material chamber is blocked with shredded plastic waste material, the compressing ram 50 is actuated to push and compress the shredded plastic waste material against the vertical wall 56. The compressing ram 50 will stop if it does not reach a predetermined pressure prior to reaching a preset position and withdraw to its original position, which creates a void for more shredded plastic waste material to fall into. The compressing ram 50 will continue to cycle until the compressing ram reaches the predetermined pressure prior to passing the preset position, at which time there is enough material in the formed compacted bundle of plastic waste to eject it from the compressing section. In one aspect, the compressing ram 50 will continuously cycle until the formed compacted bundle reaches the predetermined dimension. In one aspect, the shredded plastic waste that forms each respective compacted bundle of plastic waste is in a substantially-non-adhered state. That is, the discrete plastic waste particles are not adhered to each other via, for example, heating or the addition of an adhesive.

Optionally, the baler 40 further comprises a vertical ram 60 that is configured to cycle substantially vertically for compressing the shredded plastic waste that enters the throat 42 of the baler 40. In one aspect, the vertical ram 60 operates under a low pressure so that the shredded plastic waste material that enters the throat of the bailer is lightly compressed. Further, it is contemplated that the vertical ram 60 will only cycle when the bailing section conveyor 33 is operating, i.e., is delivering shredded plastic waste to the baler. One would appreciate that, in operation, the vertical ram acts to increase the amount of shredded plastic waste that each stroke of the compressing ram pushes into the bale, which can increase the cyclical rate of the baler.

In one aspect, the formed compacted bundle of plastic waste 66 has a predetermined size and/or shape that is dictated by the shape of the enclosure formed by the bottom portion of the material chamber, the vertical wall and the compressing ram. In one exemplary aspect, the shape is a generally rectangular shape. However, it is of course contemplated that any desired geometric shape can used. In one exemplary aspect, the rectangular shaped formed compacted bundle of plastic waste has exterior dimensions of about 13×32×22 inches. In one aspect, it is preferred that the selected shape have opposed planar surfaces to provide for ease in stacking the formed compacted bundles of plastic waste for inventory storage.

In one aspect, the formed compacted bundle 66 of plastic waste has a density of between about 5 to about 40 lbs/ft³, including additional densities of 10, 15, 20, 25, 30 and 35 lbs/ft³, with a range of between about 10 to about 30 lbs/ft³ being preferred.

In one aspect, the formed compacted bundle of plastic waste 66 has a weight of between about 30 to about 300 lbs, including additional weights of 40, 50, 60, 70, 80, 90, 100, 110, 120, 130, 140, 150, 160, 170, 180, 190, 200, 210, 220, 230, 240, 250, 260, 270, 280 and 290 lbs, with a range of between about 50 to about 120 lbs being preferred.

In a further aspect, the baler 44 comprises a means for conveying the formed compacted bundle out of the outlet port of the material chamber. In one aspect, the means for conveying the formed compacted bundle is actuated when the compressing ram 50 is signaled to stop cycling, i.e., when the formed compacted bundle of plastic waste 66 has reached the desired predetermined dimension. In one exemplary aspect, the outlet port 46 of the material chamber is positioned normal to the longitudinal path of movement of the compressing ram. In this aspect, the means for conveying the formed compacted bundle out of the outlet port comprises a conveying ram 68 that is configured for oscillating movement along a substantially horizontal longitudinal path that is substantially perpendicular to the longitudinal path of the compressing ram 50.

In one aspect, the conveying ram 68 pushes the formed compacted bundle of plastic waste out of the outlet port 46 a predetermined distance and is then directed to stop. A strapper assembly 70 is configured to wrap a strap around the compacted bundle 66 and secured the ends of the strap relative to each other to form a band about the bundle of plastic waste. In one aspect, the strap is exemplarily formed, without limitation, of PP and the strapper assembly hot melts portion of the respective ends of the strap together to secure the strap and form a polymeric band.

When the strapper assembly 70 reports a successful strap, the conveying ram 68 pushes the formed compacted bundle forward another predetermined distance and stops again, at which time the strapper assembly wraps and secures a second strap about the exterior of the formed compacted bundle. The cycle of movement of the conveying ram and the strapping of the strapper assembly is repeated until a desired number of straps are secured around the formed compacted bundle of plastic waste. Subsequently, the conveying ram 68 moves to eject the remaining portion of the formed compacted bundle out of the outlet port of the material chamber and is then returned to its original position, at which time the next cycle is initiated by depositing or dropping shredded plastic waste material into the bottom portion of the material chamber so that it can be compressed.

In alternative embodiments, the formed compacted bundle of plastic waste 66 can be secured by wrapping the bundle with a polymeric film. In another aspect, exterior portions of the formed compacted bundle of plastic waste can be exposed to a heat source (not shown) to fuse the exterior portions at least partially together so that the bundle of plastic waste retains its compressed state. In this aspect, only the fused portions of the bundle are adhered together.

Subsequently in the plastic waste stream stage, in one aspect, the strapped bundles of plastic waste 67 can be stacked on a pallet for subsequent storage and/or delivery to the processing stage. Optionally, the pallet can be initially positioned on an industrial carousel so that a convention industrial stretch machine can wrap the stacked bundles of plastic waste to ease transport to the processing stage.

In one embodiment, the rubber waste stream stage 80 can initially comprise rubber waste material 82 that is typically received in a multitude of different discrete sizes. For example, and not meant to be limiting, the rubber waste can be in large dense chunks to popcorn size pieces to light powders. As noted above, an exemplary rubber waste material forming the rubber waste stream comprises an EPDM or EPR rubber that has been rejected from any stage of a manufacturing process.

In one aspect, the received rubber waste material is deposited into a chamber of a guillotine 86 so that the rubber waste can be initially downside via a conventional guillotine. In a further aspect, a wall opposite the guillotine is moved by a horizontal piston so that throughput of a downstream rubber grinder is increased. In operation, the wall is moved toward the guillotine for a predetermined length of time, which moves the mass of deposited rubber waste material forward so that at least a portion of the rubber waste material underlies the guillotine, the wall is then paused and the guillotine is cycled. Each respective guillotine cycle starts with the guillotine in an up, non-contact, position, the guillotine then moves to the floor of the chamber through the deposited rubber waste to form a sliced portion of the deposited rubber waste material, and then is raised back to the up position. The sliced portion of the deposited rubber waste material and any loose rubber waste material that is pushed by the wall passed the guillotine is discharged from the guillotine and falls onto an upper run 94 of a conveyor belt 92 of a regrind section conveyor 90 for delivery to a conventional rubber grinder 100 such as, for example and not meant to be limiting, the grinder manufactured by Retech Film And Fiber, model RG62/150 SPK FF. The wall is then subsequently stepped forward toward the guillotine and the guillotine cycles again. The overall operation is repeated until the wall reaches the guillotine, at which time the wall is pulled back to its original starting position and the entire cycle is complete.

In one aspect, the conveyor belt 92 of the regrind section conveyor 90 is supported at opposite ends by rollers and is driven by a motor. In one aspect, the conveyor belt of the regrind section conveyor is non-foraminous. In another aspect, the discharge end of the regrind section conveyor is positioned to overlie the hopper of the rubber grinder 100. In one exemplary grinder, the ReTech grinder noted above, a ram operates of a preprogrammed cycle that uses feedback of power use to maximize efficiency of the grinder. In one aspect, the cycle can be randomized. In this randomized aspect, a timer switches between alternative programs of varying grind aggressiveness to help to prevent the grinder from becoming caught in a continuous loop in which no rubber material is actually being ground. In one exemplary aspect, the ram pushes the rubber waste material against a rotating cylinder with teeth mounted to its exterior surface to reduce the rubber waste material of the rubber waste stream into regrind particulates that have a desired size. The formed regrind particulates form a rubber regrind composition 83. In a further aspect, the grinder 60 can also comprise a screen (not shown) mounted about the rotating cylinder to ensure that the rubber waste material is reduced to the desired size.

Subsequently, the rubber regrind composition 83 is discharged from the grinder and falls onto an upper run 114 of a conveyor belt 112 of a heated section conveyor 110. In one aspect, the conveyor 112 belt of the heated section conveyor is supported at opposite ends by rollers and is driven by a motor. In one aspect, the conveyor belt of the heated section conveyor is non-foraminous. In a further aspect, the heated section conveyor 110 further comprises at least one radiant heater 116 configured to blow heated air 118 over the passing rubber regrind particulates to dry or at least reduce the moisture content of the rubber regrind particulates and to raise the temperature of the regrind particulates. In a further aspect, the heat can originate from heat lamps 119 mounted directly above the conveyor to heat the rubber through radiation. In one aspect, the heater is maintained at a temperature between about 150 to about 300 degrees C., with a preferred range of about 200 to 220 degrees C.

Further, to remove any magnetic-responsive materials, such as metal that are subject to magnetic attraction, an electromagnet 120 can be disposed above a portion of the heated section conveyor belt. In one aspect, the magnet is positioned sufficiently close to the rubber regrind composition being conveyed to attract and remove any metallic objects from the plastic waste steam.

One heated section conveyor may be sufficient to dry the regrind particulates to the desired degree as well as raise the temperature of the regrind particulates to the desired degree, which would be suitable for feeding to a means for compressing the rubber regrind composition 83. However, alternatively, it may be desirable to pass the rubber regrind particulates through at least one additional heated section conveyor. In that event, the discharge of the heated section conveyor is deposited onto the at least one additional heated section conveyor. In one aspect, the discharge from the last heated section conveyor feeds the means for compressing the rubber regrind composition.

In a further aspect, a rubber dewatering subsystem 130 can be provided. In this aspect, the rubber regrind composition is discharged from the grinder and conveyed to a holding bin. The bin in communication with an auger that is configured to meter the rubber regrind composition into a conventional dewatering press, such as for example, the dewatering press manufactured by the French Oil Press Company of Piqua, Ohio. In one aspect, the dewatering press is similar to an extruder, but, in this operation, the screw of the dewatering press squeezes the rubber regrind composition against the barrel of the dewatering press to remove any water present in the rubber regrind composition. The reduction of water content within the rubber regrind composition allows for a reduction in processing time in the Banbury.

In a further aspect, the dewatering press can pelletize the rubber regrind composition and subsequently discharge the pelletized regrind composition onto the heated section conveyor. In one exemplary aspect, the dried pelletized regrind composition can by discharged into the means for compressing the rubber regrind composition, described in more detail below. Optionally, the dried pelletized regrind composition can by discharged into gaylords for subsequent conventional delivery to the Banbury, i.e., bypassing the means for compressing the rubber regrind composition.

In exemplary embodiment, the means for compressing the rubber regrind composition 140 can comprise a controller 142; a funnel 144; a plurality of buckets 146, and a first piston 148. In one aspect, the funnel 144 is in communication with the discharge end of the last heated section conveyor 110 and is configured to receive the dried and heated regrind particulates 85. In another aspect of the system, the first piston 148 is under the operative control of the controller 142 and is configured for movement along a substantially horizontal path such that a bucket from the plurality of buckets can be selectively positioned underneath the outlet 145 of the funnel 144.

In further aspects, the means for compressing the rubber regrind composition comprises a means for depositing a predetermined weight of the dried and heated regrind composition into the bucket that is positioned underneath the outlet of the funnel; a vertical piston 150, and a second piston 152 that is configured for travel along a substantially horizontal path that is, in one aspect, angled with respect to the horizontal path of the first piston. In one aspect, the vertical piston 150 is configured for movement along a substantially vertical path and is further configured to contact and compress the dried and heated regrind particulates 85 to form a compressed rubber bundle 141 therein the bucket 146. The means for depositing a predetermined weight of the dried and heated regrind composition can comprise a scale 154 mounted under the outlet 145 of the funnel 144 that is in electrical communication with the controller. In operation, the bucket 146 is moved onto the scale 154 when the bucket is moved under the outlet of the funnel.

In one aspect of the operation of the rubber waste stream stage, the controller 142 signals a valve 156 mounted in the outlet 145 of the funnel to open 144. This allows dried and heated regrind particulates 85 to fall downward and into the bucket positioned in an underlying position relative to the outlet of the funnel. After a predetermined weight of the dried and heated regrind particulates are deposited into the bucket, the controller actuates the second piston 152 so that the bucket that underlies the outlet of the funnel is moved out of the underlying position relative to the outlet of the funnel and into an underlying position relative to the vertical piston 150 whereupon the operation of the vertical piston is initiated to compress the deposited dried and heated regrind particulates therein the bucket 85 to from the compressed rubber bundle.

In a further aspect, when the next bucket reaches its predetermined weight, the vertical piston 150 is withdrawn and the second piston 152 is actuated, which moves the next bucket under the vertical piston and resultantly moves the bucket containing the compressed rubber bundle 141 onto a roller line 158. Subsequently, the compressed rubber bundle 141, which forms a rubber patty, is removed from the bucket and is stacked for storage and/or delivery to the processing stage.

In one aspect, the predetermined weight of the formed rubber patty 141 is between about 10 to about 60 lbs, including additional weights of 15, 20, 25, 30, 35, 40, 45, 50 and 55 lbs., or between about 20 to about 50 lbs, with about 35 lbs. being preferred. In a further aspect, it is contemplated that the compression of the vertical piston onto the dried and heated regrind particulates causes at least a portion of the rubber regrind composition to fuse together in the formed compressed rubber bundle.

In a further aspect of the recycling system of the present invention, in the processing stage 160, at least one compacted bundle of plastic waste 67 and/or at least one patty 141 of rubber waste are feed into a Banbury 162 for processing into the desired reclaimed product. In this aspect, the Banbury 162 has a throat that is configured to receive the formed compacted bundle of shredded plastic waste. In one exemplary, the throat may be configured to continuously receive the formed compacted bundles of shredded plastic waste. One exemplary Banbury is the Uni-Drive, Banbury type batch mixer that is manufactured by Bolling, Model #10, with an expanded chamber for more throughput. It is of course contemplated that any intensive batch mixer, regardless of size, will work with the method of the present invention. Conventional mixer manufacturers include, for example, Farrel, Kebelco, Skinner and Stewart Bolling.

In a further aspect, it is contemplated that the formed compacted bundle of shredded plastic waste 67 has a cross-sectional shape that allows for a non-interference fit therein the throat of the Banbury. Thus, in one aspect, the cross-sectional area of the formed compacted bundle of shredded plastic waste is less than the cross-sectional area of the throat of the Banbury. Further, as the cross-sectional area of the compressed rubber bundle is less than the cross-sectional area of the formed compacted bundle of shredded plastic waste, the compressed rubber bundle(s) are readily received by the throat of the Banbury. Normally, conventional mixers require a modification to enlarge the mouth opening of the Banbury so that the material can be readily received into the Banbury.

In one exemplary aspect, it is preferred that the Banbury 162 comprise a neck extension that is mounted between the mixer and hopper of the Banbury. This allows all of the bales of the formed compacted bundles of shredded plastic waste and/or the patties of rubber waste that comprise a batch to be processed to enter the throat of the Banbury at one time. Thus, in operation, the vertical ram of the Banbury imparts downward pressure onto the batch materials until they all enter the mixing chamber. One skilled in the art will appreciate that the neck extension elongates the throat of the Banbury which thereby requires a vertical ram with a longer stroke.

In a further aspect, the Banbury can have a higher mixing speed that conventional Banbury's. In this aspect, the higher mixing speed can be obtained by use of a lower ratio gearbox. Optionally, the higher mixing speed can be obtained by use of a faster RPM motor. For the exemplary Uni-Drive, Banbury type batch mixer noted above, typical operational speed range from between about 50 to 120 RPM. In another aspect, the rotor of the Banbury can have at least two wing rotors, with four wing roters being preferred.

In a further aspect of the invention, in the processing stage 160, the system further comprises a means for conveying the compacted bundle of shredded plastic waste to the throat of the Banbury 164 and a means for conveying the compresses rubber bundle to the throat of the Banbury 166. In one exemplary aspect, the respective bundles could be lifted to the throat via a lift, such as a fork lift. Alternatively, the respective means for conveying the compacted bundle of shredded plastic waste and the compressed rubber bundle comprises a processing conveyor 170 having a discharge end in communication with the throat of the Banbury, which, in one aspect, is selectively movable. The processing conveyor can comprise a conveyor belt 172 supported at opposite ends by rollers and is driven by a motor.

Further, the processing conveyor can also comprise at least one load sensor 174 that is configured for sensing the weight of a batch of materials that are placed on the upper surface of the conveyor belt. In one exemplary aspect, it is contemplated that the batch of materials comprises at least a portion of one compacted bundle of shredded plastic material and at least a portion of one compressed rubber bundle such that a select quantity of the shredded plastic waste material and a selected quantity of the compressed rubber bundles can be delivered to the throat of the Banbury. In another exemplary aspect, it is contemplated that the batch of materials comprises at least a portion of one compacted bundle of shredded plastic material that are delivered to the throat of the Banbury. In a further exemplary aspect, it is contemplated that the batch of materials comprises at least a portion of one compressed rubber bundle that are delivered to the throat of the Banbury. The load sensor allows an operator to determine the relative weights of the respective select quantities of the shredded plastic waste material and the selected quantity of the compressed rubber bundles that have been placed on the upper surface of the conveyor belt for delivery to the Banbury, i.e., to measure the batch weight.

It is contemplated that regrind materials can be added to the batch to reach the desired batch weight. In a further aspect, additional additives, such as, for example and without limitation, colorants such as carbon black and black palletized colorant, fillers such as talc and mica, reinforcers such as glass fibers, stabilizers such as heat stabilizers and UV stabilizers, and the like, can be placed onto the conveyor with the batch or, optionally, blown or otherwise conveyed directly into the throat of the Banbury.

### PRODUCTION EXAMPLES

The following examples are put forth so as to provide those of ordinary skill in the art with a complete disclosure and description of how the devices, systems and methods claimed herein are made, performed and evaluated. These examples are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is degrees C. or is at ambient temperature, and pressure is at or near atmospheric.

### Example 1

Preparation of a pelletized, impact modified composition for general purpose and medium impact injection applications comprising polypropylene 100% recycled content as defined by ASTM D-5033.

An exemplary pelletized, impact modified composition could be prepared according to the exemplary procedures set forth below. In one aspect, the formed composition has a substantially uniform color (in this example, black) and shape. The formed composition has the following general physical properties:

| | |
|---|---|
| MFR: 230/2.16 | 10.0–16.0 |
| Tensile Stress | 2400 min |
| Flex Modulus | 100–140 kpsi |
| Izod Impact | 4.0 min |
| Inorganic Content | 0.0–4.0 |
| Dart Impact @ 23° C. | 200 min |
| Specific Gravity | 0.901–0.935 |
| Color/Appearance | Visual to P-202 Standard (lab B2) |
| IR Scan | Compare to 2019 SUNSP file (B5) |

Each individual batch that is delivered to the Banbury in this example comprises:
2 compacted bundles of shredded plastic waste material formed from diaper material (with an approximate total weight of 201 lbs.) forming approximately 53.0% of the individual batch;
2 compressed rubber bundles of EPR material, having a low-melt viscosity in the range of about 0-15 MI (with an approximate total weight of 61 lbs.), forming approximately 16.0% of the individual batch;
1 compressed rubber bundle of SBL rubber for use as an impact modifier, having a mid-melt viscosity in the range of about 16-30 MI (with an approximate total weight of 84 lbs.), forming approximately 22.0% of the individual batch;
Approximately 6 lbs. of color pellets that are carbon black filed, forming approximately 1.5% of the individual batch; and
Approximately 29 lbs. of ground copolymer polypropylene, forming approximately 7.5% of the individual batch. This amount can vary to adjust for deviations in bale weight.

The individual batches are sequentially run through the Banbury until a complete production cycle is complete. In this example, each individual batch weighs about 380 lbs. and the batches are run until a production cycle of at least 75,000 lbs. has been complete.

### Example 2

Preparation of a pelletized, pre-colored impact modified copolymer for general purpose and medium impact injection applications comprising polypropylene 100% recycled content as defined by ASTM D-5033.

An exemplary pelletized, pre-colored impact modified composition could be prepared according to the exemplary procedures set forth below. In one aspect, the formed composition has a substantially uniform color (in this example, black) and shape. The formed composition has the following general physical properties:

| | Target | Range |
|---|---|---|
| MFR: 230/2.16 | 20.9 | 13.0–17.0 |
| Tensile Stress | 3695 | 3500 min |
| Elong. @ yield | 9.3 | 6.0–12.0 |
| Flex Modulus | 148 kpsi | 125–175 kpsi |
| Izod Impact | 2.10 | 1.50 min |
| Dart Impact @ 23° C. | 158 | 120 min |
| Dart Impact @ 29° C. | 42 | 20 min |
| Specific Gravity | 0.914 | 0.904–0.923 |
| Oven Oxidation 150° C. | 3761 | 3500 Tensile 240 hr |
| (Failure criteria as per | 1.96 | 1.5 Izod 240 hr |
| MSDB 543) | | |
| Heating Deflection | 84.0 | 46 min @ 66 psi |
| (Failure criteria as per | 53.2 | 77 min @ 264 psi |
| MSDB 543) | | |

Each individual batch that is delivered to the Banbury in this example comprises:
1 compacted bundle of shredded plastic waste material formed from diaper material (with an approximate total weight of 103 lbs.) forming approximately 27.0% of the individual batch;
1 compacted bundle of shredded plastic waste material formed from homopolymer polypropylene (with an approximate total weight of 76 lbs.) forming approximately 20.0% of the individual batch;
½ of a compressed rubber bundle of SBL rubber for use as an impact modifier, having a mid-melt viscosity in the range of about 16-30 MI (with an approximate total weight of 46 lbs.), forming approximately 12.0% of the individual batch;
½ of a compacted bundle of shredded plastic waste material formed from diaper material (with an approximate total weight of 46 lbs.) forming approximately 12.0% of the individual batch;
1 compressed rubber bundle of EPR material, having a low-melt viscosity in the range of about 0-15 MI (with an approximate total weight of 30 lbs.), forming approximately 8.0% of the individual batch;
Approximately 11 lbs. of color pellets that are carbon black filed, forming approximately 3.0% of the individual batch; and
Approximately 68 lbs. of ground copolymer polypropylene, forming approximately 18.0% of the individual batch. This amount can vary to adjust for deviations in bale weight.

The individual batches are sequentially run through the Banbury until a complete production cycle in complete. In this example, each individual batch weighs about 380 lbs. and the batches are run until a production cycle of at least 75,000 lbs. has been complete.

### Example 3

Preparation of a pelletized, impact modified copolymer for general purpose and high impact injection applications comprising polypropylene 100% recycled content as defined by ASTM D-5033.

An exemplary pelletized, pre-colored impact modified composition could be prepared according to the exemplary procedures set forth below. In one aspect, each individual batch that is delivered to the Banbury in this example comprises:
1 compacted bundle of shredded plastic waste material formed from copolymer polypropylene (with an approximate total weight of 93 lbs.) forming approximately 24.60% of the individual batch;
1 compacted bundle of shredded plastic waste material formed from biaxial oriented polypropylene film (with an approximate total weight of 93 lbs.) forming approximately 24.6% of the individual batch;
6 compressed rubber bundles of EPR material, having a low-melt viscosity in the range of about 0-15 MI (with an approximate total weight of 190 lbs.), forming approximately 50.0% of the individual batch; and
Approximately 3 lbs. of color pellets that are carbon black filed, forming approximately 0.8% of the individual batch.

The individual batches are sequentially run through the Banbury until a complete production cycle in complete. In this example, each individual batch weighs about 380 lbs. and the batches are run until a production cycle of at least 12,000 lbs. has been complete.

What is claimed is:

1. A recycling system, comprising:
a source of shredded plastic waste; and
a baler comprising:
a throat in communication with the source of shredded plastic waste,
a material chamber in communication with the throat, wherein the material chamber defines an outlet port,
a compressing ram configured to form a compacted bundle of plastic waste weighing about and between 30 to 300 lbs, wherein the shredded plastic waste forming the each compacted bundle of plastic waste are in a non-adhered state, and
a means for conveying the formed compacted bundle of shredded plastic waste out of the outlet port of the material chamber.

2. The recycling system of claim 1, wherein the source of shredded plastic waste comprises a shredder configured for shredding the plastic waste into discrete pieces having a desired maximum dimension.

3. The recycling system of claim 2, wherein the source of shredded plastic waste further comprises a means for removing at least a portion of the contaminants entrained therein the polymer products.

4. The recycling system of claim 2, wherein the shredder further comprises a means for controlling the shredder such that the shredder is signaled off when the baler is sensed in a full condition and such that the shredder is signaled on when the baler is sensed in a less than full condition.

5. The recycling system of claim 1, further comprising a means for controlling the compressing ram of the baler such that the compressing ram is signaled to stop cycling when the formed compacted bundle of shredded plastic waste has a predetermined dimension.

6. The recycling system of claim 5, wherein the compressing ram is configured to cycle substantially horizontally at a bottom portion of the material chamber.

7. The recycling system of claim 5, wherein the formed compacted bundle of shredded plastic waste has a predetermined size.

8. The recycling system of claim 5, wherein the formed compacted bundle of shredded plastic waste has a density of between about 5 to about 40 lbs/ft³.

9. The recycling system of claim 5, wherein the formed compacted bundle of shredded plastic waste has a density of between about 10 to about 30 lbs/ft³.

10. The recycling system of claim 5, wherein the formed compacted bundle of shredded plastic waste has a predetermined shape.

11. The recycling system of claim 5, wherein the compressing ram cycles continuously until the compacted bundle of shredded plastic waste reaches the predetermined dimension.

12. The recycling system of claim 5, wherein the means for conveying the formed compacted bundle of shredded plastic waste out of the outlet port of the material chamber is cycled when the compressing ram is signaled to stop cycling.

13. The recycling system of claim 12, wherein the outlet port of the material chamber is positioned normal to the longitudinal path of movement of the compressing ram, and wherein the means for conveying the formed compacted bundle of shredded plastic waste out of the outlet port of the material chamber comprises a conveying ram configured for movement along a longitudinal path substantially perpendicular to the longitudinal path of movement of the compressing ram.

14. The recycling system of claim 1, wherein the baler further comprises a vertical ram configured to cycle substantially vertically for compressing the shredded plastic waste that enters the throat of the baler.

15. The recycling system of claim 1, further comprising a means for strapping the formed compacted bundle of shredded plastic waste with a polymeric band.

16. The recycling system of claim 1, wherein the plastic waste is mixed-grade plastic waste.

17. The recycling system of claim 1, wherein the plastic waste is single-grade plastic waste.

18. The recycling system of claim 1, wherein the plastic waste is selected from a group consisting of polypropylene, polyethylene, SBL rubber, and TPO.

19. The recycling system of claims 1 or 8, further comprising:
a Banbury having a throat configured to receive the formed compacted bundle of shredded plastic waste; and
a means for conveying the compacted bundle of shredded plastic waste to the throat of the Banbury.

20. The recycling system of claim 19, wherein the throat of the Banbury has a throat configured to continuously receive the formed compacted bundles of shredded plastic waste.

21. The recycling system of claim 19, wherein the formed compacted bundle of shredded plastic waste has a cross-sectional shape allows for a non-interference fit therein the throat of the Banbury, and wherein the cross-sectional area of the formed compacted bundle of shredded plastic waste is less than the cross-sectional area of the throat of the Banbury.

22. The recycling system of claim 19, further comprising a means for compressing a rubber regrind composition to form a compressed rubber bundle in which at least a portion of the rubber regrind composition is fused together.

23. The recycling system of claim 22, wherein the rubber regrind composition comprises an EPDM rubber.

24. The recycling system of claim 22, further comprising a means for conveying the compressed rubber bundle to the throat of the Banbury.

25. The recycling system of claim 24, wherein the respective means for conveying the compacted bundle of shredded plastic waste and the compressed rubber bundle comprises a conveyor.

26. The recycling system of claim 25, wherein the conveyor is selectively movable.

27. The recycling system of claim 25, wherein the conveyor comprises at least one load sensor configured for sensing the weight of a batch of materials placed on the conveyor.

28. The recycling system of claim 27, wherein the batch of materials comprises at least a portion of one compacted bundle of shredded plastic waste and at least a portion of one compressed rubber bundle.

29. The recycling system of claim 19, wherein the throat of the Banbury has a longitudinal dimensional that is sized to accept a plurality of compacted bundles of shredded plastic waste having a weight of between about 50 to 120 lbs.

30. A recycling system, comprising:
a means for compressing a rubber regrind composition to form a compressed rubber bundle in which at least a portion of the rubber regrind composition is fused together;
a Banbury having a throat configured to receive the formed compressed rubber bundle; and
a means for selectively conveying the formed compressed rubber bundle to the throat of the Banbury.

31. The recycling system of claim 30, wherein the rubber regrind composition comprises an EPDM rubber.

32. The recycling system of claim 30, wherein the rubber regrind composition comprises an EPR rubber.

33. The recycling system of claim 30, further comprising a grinder configured to reduce a rubber waste stream into regrind particulates having a desired size that forms the rubber regrind composition.

34. The recycling system of claim 33, herein the grinder operates on a randomized grind cycle.

35. The recycling system of claim 33, further comprising:
a conveyor in communication with the grinder that is configured to receive the regrind particulates from the grinder; and
at least one heater configured to dry the regrind particulates and to raise the temperature of the regrind particulates.

36. The recycling system of claim 33, wherein the means for compressing a rubber regrind composition comprises:
a controller;
a funnel defined an outlet, wherein the funnel is in communication with the conveyor to receive the dried and heated regrind particulates;
a plurality of buckets;
a first piston, under operative control of the controller, which is configured for horizontal movement and for selectively positioning the bucket to underlie the outlet of the funnel;
a means for depositing a predetermined weight of the dried and heated regrind particulates therein the bucket;
a vertical piston that is configured for compressing the dried and heated regrind particulates to form the compressed rubber bundle; and
a second piston that is configured for horizontal travel,
wherein, upon sensing of the predetermined weight being positioned therein a filled bucket, the controller actuates the second piston to move the filled bucket out of the underlying position, signals the first piston to move an empty bucket to the underlying position relative to the vertical piston, and initiates the operation of the vertical piston to form the compressed rubber bundle.

37. The recycling system of claims 30 or 36, wherein the compressed rubber bundle weighs between about 20 to 50 lbs.

38. The recycling system of claim 30, further comprising:
a means for forming a compacted bundle of shredded plastic waste from a stream of shredded plastic waste, wherein the shredded plastic waste forming each compacted bundle of shredded plastic waste is in a non-adhered state, and
a means for conveying the formed compacted bundle of shredded plastic waste out of the outlet port of the material chamber.

39. The recycling system of claim 38, further comprising a means for strapping the formed compacted bundle of shredded plastic waste with a polymeric band.

40. The recycling system of claim 38, further comprising a means for conveying the compacted bundle of shredded plastic waste to the throat of the Banbury.

41. The recycling system of claim 40, wherein the respective means for conveying the compacted bundle of plastic waste and the compressed rubber bundle comprises a conveyor.

42. The recycling system of claim 41, wherein the conveyor is selectively movable.

43. The recycling system of claim 41, wherein the conveyor comprises at least one load sensor configured for sensing the weight of a batch of materials placed on the conveyor.

44. The recycling system of claim 43, wherein the batch of materials comprises at least a portion of one compacted bundle of shredded plastic waste and at least a portion of one compressed rubber bundle.

45. The recycling system of claim 44, wherein the throat of the Banbury has a longitudinal dimensional that is sized to accept a plurality of compacted bundles of shredded plastic waste having a weight between about 50 to about 120 lbs.

46. A method of recycling using waste steam products, comprising:
providing a source of shredded plastic waste, wherein the source of shredded plastic waste comprises a plurality of compacted bundles of non-adhered shredded plastic waste, wherein each compacted bundle of non-adhered shredded plastic waste weighs between about 30 to 300 lbs.;
providing a source of compressed rubber bundles, wherein each compressed rubber bundles is formed from a rubber regrind composition such that at least a portion of the rubber regrind composition is fused together, wherein each compressed rubber bundle weighs between about 10 to 60 lbs.;
providing a Banbury having a throat configured to receive at least one formed compacted bundle of shredded plastic waste and at least on compressed rubber bundles;
providing a means for conveying a selected quantity of the compacted bundles of shredded plastic waste and a selected quantity of the compressed rubber bundles to the throat of the Banbury; and
feeding the selected quantity of the compacted bundles of shredded plastic waste and the selected quantity of the compressed rubber bundles to the throat of the Banbury.

47. The method of claim 46, wherein the throat of the Banbury has a throat configured to continuously receive the formed compacted bundles of shredded plastic waste.

48. The method of claim 46, wherein the formed compacted bundle of shredded plastic waste has a cross-sectional shape allows for a non-interference fit therein the throat of the Banbury, and wherein the cross-sectional area of the formed compacted bundle of shredded plastic waste is less than the cross-sectional area of the throat of the Banbury.

49. The method of claim 46, wherein the respective means for conveying the selected quantities of compacted bundles of shredded plastic waste and the compressed rubber bundles comprises a conveyor.

50. The method of claim 49, wherein the conveyor is selectively movable.

51. The method of claim 49, further comprising sensing a weight of a batch of materials placed on the conveyor.

52. The method of claim 51, wherein the batch of materials comprises the select quantity of compacted bundles of shredded plastic waste and the select quantity of compressed rubber bundles.

53. The method of claim 48, wherein the throat of the Banbury is configured to accept a plurality of compacted bales.

54. The method of claim 46, wherein each compacted bundle of shredded plastic waste has a density of between about 5 to about 40 lbs/ft³.

55. The method of claim 46, wherein each compacted bundle of shredded plastic waste has a density of between about 10 to about 30 lbs/ft³.

56. The method of claim 46, wherein the shredded plastic waste is mixed-grade plastic waste.

57. The method of claim 46, wherein the shredded plastic waste is single-grade plastic waste.

58. The method of claim 46, wherein the shredded plastic waste is selected from a group consisting of polypropylene, polyethylene, SBL rubber, and TPO.

59. The method of claim 46, wherein the rubber regrind composition comprises an EPDM rubber.

60. The method of claim 46, wherein the rubber regrind composition comprises an EPR rubber.
